(19) United States
(12) Patent Application Publication
(10) Pub. No.: US 2017/0120567 A1
(43) Pub. Date: May 4, 2017

(54) DIRECT BONDING METHOD

(71) Applicant: COMMISSARIAT À L'ENERGIE ATOMIQUE ET AUX ENERGIES ALTERNATIVES, Paris (FR)

(72) Inventors: Frank FOURNEL, Villard-Bonnot (FR); Damien RADISSON, Grenoble (FR)

(73) Assignee: COMMISSARIAT À L'ENERGIE ATOMIQUE ET AUX ENERGIES ALTERNATIVES, Paris (FR)

(21) Appl. No.: 15/318,176

(22) PCT Filed: Jun. 9, 2015
(86) PCT No.: PCT/FR2015/051516

§ 371 Date: Dec. 12, 2016

(30) Foreign Application Priority Data
Jun. 12, 2014 (FR) 14/55356

(51) Int. Cl. B32B 37/00; B32B 38/18; B32B 37/12

(52) U.S. Cl. CPC B32B 37/003; B32B 37/1284; B32B 38/1841; B32B 2309/68

(57) ABSTRACT

The invention relates to a method for directly adhering a lower substrate to an upper substrate which includes the following steps: a) providing a mounting; b) positioning the lower substrate on the mounting, the mounting being configured such as to raise a portion of the lower substrate; c) positioning the upper substrate above the lower substrate; d) allowing the upper substrate to fall by gravity onto the lower substrate such as to form an initial contact point between the upper substrate and the lower substrate, located on the raised portion of the lower substrate; and e) completing the contact between the upper substrate and the lower substrate such as to adhere the upper substrate to the lower substrate by direct adhesion.

The present invention concerns a direct bonding method between a lower substrate and an upper substrate.

The direct bonding is a technique industrially used for numerous applications. The direct bonding is in particular used in the manufacture of SOI by Smart Cut™, for the creation of backlit imagers and also in the MEMS and NEMS. In general, this bonding does not require the addition of adhesive material between the two surfaces to be bonded, is carried out at ambient temperature and ambient pressure. Under these conditions, when placing two substrates, of silicon for example, one above the other, the upper substrate is left free above the lower substrate and comes close to said lower substrate by gravity. After a few moments, the surfaces are close enough such that the direct bonding starts at a particular location of the interface, which depends on the topology of the surfaces of the carriers. This direct bonding is in particular engaged by the presence of Van der Waals forces between the two surfaces to be bonded. Once started, the bonding propagates step by step by bringing closer the surfaces and releasing the residual air located between the two surfaces. It is thus possible to obtain a direct bonding of two 300 mm diameter silicon substrates simply by gravity.

However, if no specific control is operated, the contacting of the two surfaces may occur at two different locations and generate two bonding waves simultaneously propagating. When these two bonding waves meet, the air is trapped at the interface, which generates a bonding defect. In order to overcome this drawback, it is known to apply a local pressure on the upper substrate in order to control the initiation position of the direct bonding. This pressure may be maintained so as to cause a deformation of the surfaces, thus preventing the emergence of a secondary bonding wave. But this distortion must, however, remain low enough in order not to prevent the propagation of the first bonding wave.

In automatic bonding machines, this pressure is in general exerted by means of a mechanical arm which force is controlled or alternatively by applying an air jet whose pressure on the surface of the upper substrate is controlled. This method is complex to implement and may sometimes prove to be ineffective. Indeed, for numerous applications, a vacuum bonding is necessary, in particular in the case where cavities are present at the bonding interface and in which it is undesirable to trap the air. But, if the vacuum is significant enough, typically lower than 1 mbar, the direct bonding is excessively fast. The bonding starts and propagates indeed, as soon as the upper substrate is released above the lower substrate, even before the mechanical control systems (mechanical arm . . . ) have time to be operative. Thus, the origin point of the bonding wave is not controlled, and the creation of a secondary bonding wave may occur.

Moreover, there are also devices which do not freely release the upper substrate above the lower substrate. The surfaces to be bonded may not therefore be deformed to mutually adapt the topology thereof to the atomic level, such that it is difficult to carry out a direct bonding without bonding defect. These devices are thus very complex to be set and remain very expensive.

One of the objects of the invention thus consists in controlling the generation of the bonding wave under vacuum or at ambient pressure, so as to prevent the occurrence of a secondary bonding wave. To this end, the present invention provides a direct bonding method between a lower substrate and an upper substrate comprising the following steps:

a) providing a carrier,

b) positioning the lower substrate on the carrier, the carrier being configured so as to raise a portion of the lower substrate,

c) positioning the upper substrate above the lower substrate,

d) allowing the falling by gravity of the upper substrate on the lower substrate so as to form an initial contact point between the upper substrate and the lower substrate, located on the raised portion of the lower substrate, and

e) completing the contacting of the upper substrate and the lower substrate so as to bond the upper substrate and the lower substrate by direct bonding.

The expression <<direct bonding>> means in the present application a bonding by molecular adhesion between the two substrates, in the absence of glue or adhesive.

Thus, thanks to the configuration of the carrier forming a raised portion in the lower substrate and to the disposition of the upper substrate above the raised portion, the falling by gravity of the upper substrate allows selecting the location of the initial contact point between the upper substrate and the lower substrate. The initiation of the bonding is thus carried out at the initial contact point and the propagation of the bonding is obtained by forming a single bonding wave.

Indeed, this configuration allows the air possibly present between the two substrates in step c) easily and progressively escaping on either side of the raised portion, thus controlling the formation of the initial contact point and the start of the bonding wave. The step d) of falling the upper substrate only by gravity according to the invention provides an implementation of the simple method to be carried out by comparison with a technique for controlling the initiation of the bonding wave by applying a local pressure. The method according to the invention avoids indeed, the movement of parts and enables minimizing the defects induced by the application of a local pressure.

It is understood in the present document that the carrier is configured so as to raise a portion of the lower substrate relative to a second portion of the lower substrate.

The raise of a portion of the lower substrate is sufficient to enable carrying out step c) under a vacuum atmosphere, and in particular under a pressure lower than 100 Pa, while preventing the occurrence of a secondary bonding wave.

According to a disposition, step a) of providing a carrier comprises the provision of a plate and a raising member arranged on the plate, the plate and the raising member being configured to deform the lower substrate by gravity, so as to form said raised portion and an inflection zone in the lower substrate in step b).

Of course, the amplitudes of the deformation of the lower substrate by gravity and of the inflection zone are limited so as to remain compatible in terms of flatness with the conditions in order to obtain a direct bonding. For example, a conventional bow which does not disrupt the direct bonding is about 30 micrometers for a 200 mm diameter substrate.

It is also understood in the present document that the deformation of the lower substrate in step b) of the method remains in the field of the elastic deformation such that, positioned on a flat surface, the deformed lower substrate regains its initial flatness or its intrinsic bow. The deformation of the lower substrate, relative to the initial geometry thereof prior to the positioning on the plate, prevents the occurrence of a secondary bonding wave, under vacuum (typically a pressure lower than 100 Pa) but also during a bonding of step d) carried out under an atmosphere greater than or equal to vacuum, in particular under a pressure comprised between 100 Pa and 1013 hPa. Indeed, in the presence of air between the two surfaces to be bonded and in the absence of deformation of the lower substrate, once the fall of the upper substrate is allowed, the latter is positioned parallel to the lower substrate and the bonding may be thus initiated at different locations. The introduction of the deformation enables locating the initiation at the raised portion. Thus, the defects associated with the presence of air bubbles trapped at the bonding interface coming from the formation of several bonding waves between the two substrates are avoided.

In order to control the deformation and the inflection zone of the lower substrate, the raising member typically has a height comprised between 0.05 and 3 times the thickness of the lower substrate, and typically a thickness comprised between 0.2 and twice the thickness of the lower substrate.

Alternatively, and according to the same objective, the raising member is configured to be adjustable in height and the method comprises prior to step d) a step m) consisting in adjusting the height of the raising member. This configuration thus enables adjusting the height of the raising member so as to induce the desired deformation of the lower substrate, in particular a deformation greater than or equal to the intrinsic bow of the lower substrate.

According to one possible embodiment, the raising member extends through the thickness of the plate. It is thus possible to remove the raising member or at least to level the level thereof to the level of the plate in particular once the bonding wave has been detected.

According to a variant, the raising member is a removable spacer. It is thus easy to remove the spacer when the bonding wave is generated.

According to another variant, the plate is integral with the raising member. The implementation of the method according to the invention is thus simple to carry out to the extent that it is not necessary to position a raising member on a plate or to adjust the height of this member.

Preferably, the carrier provided in step a) comprises a portion of receiving the lower substrate, the receiving portion being flat, and step c) comprising the positioning of the upper substrate substantially parallel to the receiving portion of the carrier.

In other words, after step b) the substrate comprises a bonding surface having a median plan compatible in terms of flatness with the constraints associated with the direct bonding and step c) comprises the positioning of the upper substrate substantially parallel to the median plane of the bonding surface of the lower substrate.

The expression ‘substantially parallel’ means in the present application ‘parallel’ or forming an angle which may vary between 0 and 5°. Thus, the parallelism of the upper substrate with the receiving portion and the location of the initial contact point on the raised portion of the lower substrate are always ensured whether the bonding is performed at atmospheric pressure, such as about 1013 hPa, or under vacuum and in particular under a pressure lower than 1 mbar. Indeed, at ambient pressure, the air between the two substrates forms a parachute effect when the upper substrate falls by gravity. Thus, the upper substrate is naturally placed parallel to the raised portion of the lower substrate, ensuring the creation of one single bonding wave. In this last case, the use of a slightly larger angle is possible, the angle may in particular vary between 0 and 15°. But when the substrate falls by gravity and under a reduced pressure, and in particular under a pressure lower than 1 mbar, the natural adjustment of the parallelism between the two substrates is no longer ensured such that this step c) with an angle varying between 0 and 5° enables keeping the control of the location of the bonding wave in the absence of air.

According to a variant, the method comprises prior to step b) a step i) consisting in inclining the carrier relative to the horizontal at an angle of inclination α. In case of vacuum bonding, this inclination may be enough on its own to raise a portion of the lower substrate and to enable obtaining one single bonding wave. In case of bonding under ambient atmosphere, the lower substrate is not only deformed by gravity due to the presence of the raising member but it is also generally inclined relative to the horizontal at the angle a at the time of the formation of the initial contact point. Thus, for a given height of the raising member, it is possible to better control the deformation and the closing speed of the upper substrate towards the inclined lower substrate and to play on the impact of the gravity force.

Typically, the angle of inclination (α) is greater than 0 and lower than or equal to 85°, preferably, the angle of inclination (α) is greater than 0 and lower than or equal to 45°.

According to one possibility, step i) consisting in inclining the carrier is carried out by providing a device for adjusting the angle of inclination α of the carrier. The control of the angle of inclination α may be therefore accurate and adjusted case by case.

According to another possibility, step i) consisting in inclining the carrier and positioning a pad under the carrier.

According to another variant, the carrier provided in step a) comprises a receiving portion of the lower substrate, the receiving portion being generally inclined relative to the horizontal at an angle of inclination α. In this variant, the carrier is monobloc, it is formed of one piece whose surface is inclined.

According to a disposition, the carrier comprises at least one stop configured so that at least one peripheral part of the upper substrate and at least one peripheral part of the lower substrate are aligned against the stop, in particular in step d) of the method. This is in particular useful to facilitate the at least partial covering of the lower substrate and the upper substrate in particular when the carrier is inclined at an angle of inclination α relative to the horizontal.

Preferably, step c) consists in positioning the upper substrate above the lower substrate so that the upper substrate covers at least one part of the lower substrate.

More preferably, step d) of the method consists in allowing the fall by gravity of the upper substrate on the lower substrate so that the initial contact point between the upper substrate and the lower substrate is located in vertical alignment with the raising member.

Advantageously, the method comprises a step k) for detecting the bonding wave between the upper substrate and the lower substrate. This detection can be carried out by any adapted means, such as a pressure sensor disposed on the raised portion of the lower substrate prior to the bonding, an optical device (in particular infrared), or even an acoustic device . . . .

Preferably, the method comprises after step d) a step I) comprising a lowering of the deformation of the lower substrate when the bonding wave is detected. It is indeed possible to consider that the formation of a secondary bonding wave is improbable once at least 10%, and preferably more than 50%, of the surface of the substrates is bonded.

The expression <<lowering of the deformation of the lower substrate>> means in the present document the flattening of the lower substrate and the leveling of the inflection zone.

According to a possibility, the raising member is disposed on the plate so as to underlie a peripheral edge of the lower substrate. The initial contact point between the lower substrate and the upper substrate is thus formed of a peripheral edge of the lower substrate. The bonding wave thus propagates from this peripheral edge. The removal of the raising member is simple to carry out once the bonding wave is initiated.

According to another possibility, the raising member is disposed on the plate so as to underlie a central part of the lower substrate. The bonding wave is thus transmitted all around the initial contact point so that the propagation of the wave is centrosymmetric. It arises therefom that the period required to the bonding of all surfaces of the substrates is reduced compared with a positioning of the raising member under a peripheral edge of the lower substrate.

According to a possibility, the raising member is movable in translation so as to facilitate the adjustment of the height thereof.

According to a variant, the raising member comprises a threading enabling adjusting the height thereof by screwing.

According to a disposition, the raising member generally comprises the shape of a finger passing through the thickness of the plate.

Other aspects, objects and advantages of the present invention will appear better on reading the following description of different embodiments thereof, given by way of non-limiting examples and made with reference to the appended drawings. The figures do not necessarily meet the scale of all shown members so as to improve the readability thereof. In the following description, for sake of simplification, identical, similar or equivalent members of the different embodiments bear the same numerical references.

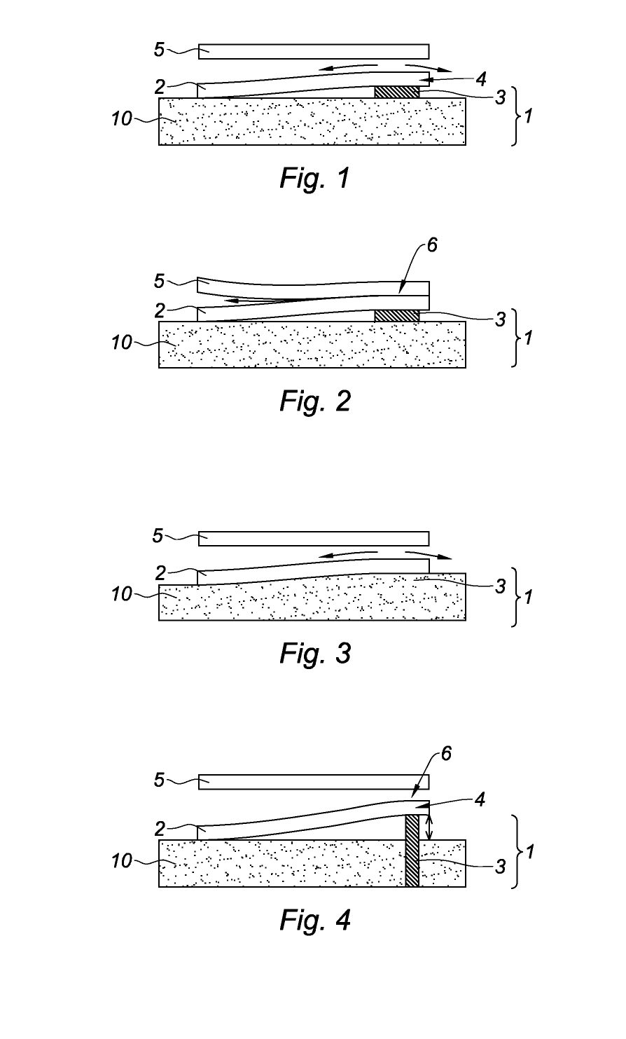

FIGS. 1 and 2 illustrate a direct bonding according to a first embodiment of the invention.

FIG. 3 illustrates a direct bonding according to a variant of the first embodiment of the invention.

FIG. 4 illustrates a direct bonding according to another variant of the first embodiment of the invention.

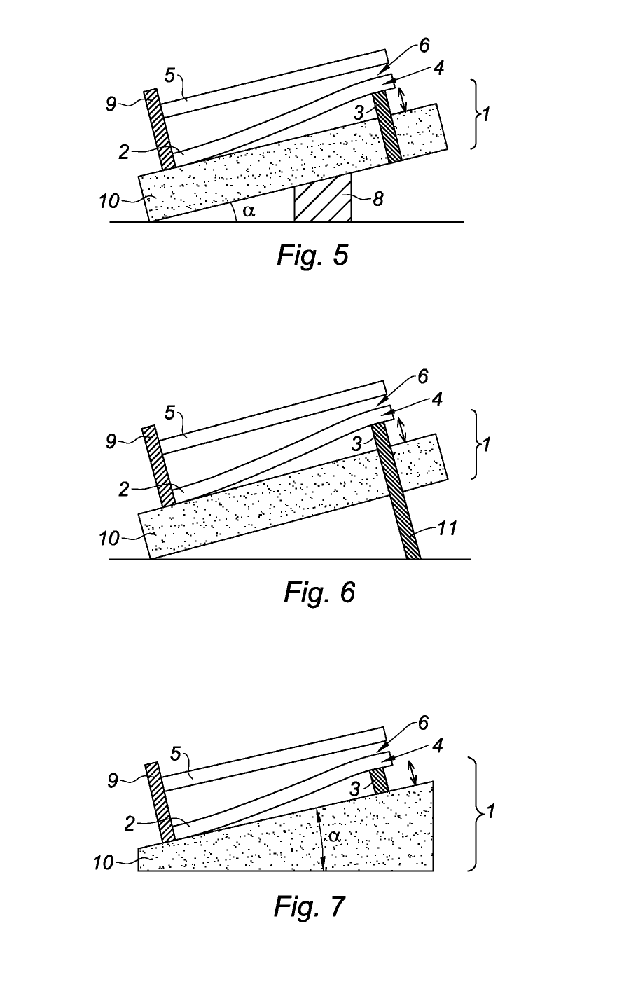

FIG. 5 illustrates a direct bonding according to a second embodiment of the invention.

FIG. 6 illustrates a direct bonding according to a variant of the second embodiment of the invention.

FIG. 7 illustrates a direct bonding according to another variant of the second embodiment of the invention.

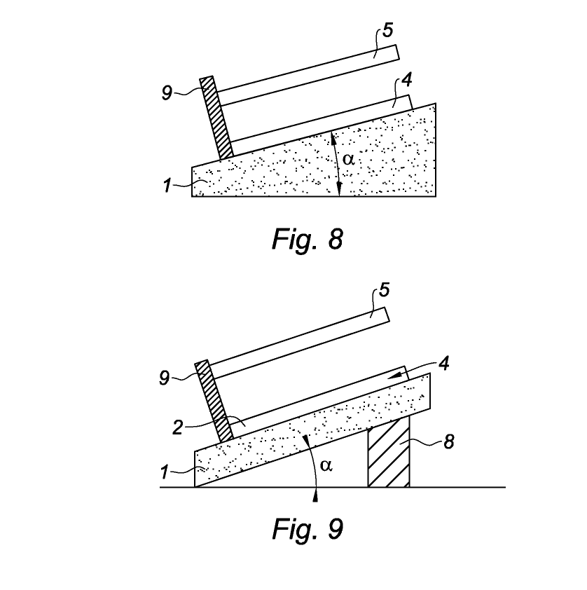

FIG. 8 illustrates a direct bonding according to yet another embodiment of the invention.

FIG. 9 illustrates a direct bonding according to a variant of the embodiment illustrated in FIG. 8.

FIG. 1 shows a carrier 1 on which is positioned a lower substrate 2, such as a silicon substrate with a diameter of 200 mm and a thickness of 725 micrometers prepared for the bonding (surface roughness lower than 0.2 nm RMS measured by AFM on a field of 5×5 micrometers and particulate contamination lower than 20 particles in a diameter range from 90 to 500 nm measured by a Surfscan SP2 type detector). The carrier 1 comprises a plate 10 and a raising member 3, such as a removable silicon spacer of a height of 200 micrometers and including a base having dimensions smaller than the dimensions of the lower substrate 2 (typically lower by 20% or even 10% or 5% than the surface of the lower substrate) and about 10×10 mm. This spacer 3 is inserted between the plate 10 and the lower substrate 2 (steps a and b). The raising member 3 thus raises a portion 4 of the lower substrate 2 with respect to a second portion of the lower substrate 2 in contact with the plate 10. This raising leads to a deformation by the effect of gravity and to the formation of an inflection zone in the lower substrate 2 with respect to its initial shaping. Then, an upper substrate 5, identical to that of the lower substrate 2, is positioned in vertical alignment with the lower substrate 2 as illustrated in FIG. 1 (step c). The upper substrate 5 is then free from any restraint, such that it falls by gravity on the deformed lower substrate 2, under an atmosphere having a pressure typically comprised between 100 Pa and 1013 hPa. As illustrated in FIG. 2, the initial contact point 6 of the two substrates 2, 5 is located on the raised portion 4 of the lower substrate 2, in vertical alignment with the raising member 3 so as to enable a good flow of the air on either side of the initial contact point 6 (referring to the arrows in FIG. 1). An infrared camera enables detecting the initiation of the bonding wave (not illustrated). The bonding wave appears after a few tens of seconds and releases the air from the initial contact point 6. The shape of the air flow, due to the deformation of the lower substrate 2, prevents the occurrence of a secondary bonding wave. Once the bonding is initiated, the raising member 3 is removed (not shown—step I) so as to obtain the straightening up of the lower substrate 2 by lowering the raised portion 4, leading to a stack of the two substantially flat bonded substrates 2, 5.

Of course, this direct bonding may also be carried out alternatively under a vacuum pressure, in particular under a pressure lower than 100 Pa without generating secondary bonding wave (not illustrated).

FIG. 3 illustrates a variant of the method which differs from the preceding embodiment in that the raising member 3 is integral with the plate 10. The lower substrate 2 positioned on the carrier 1 is therefore deformed by gravity following the shaping of the carrier 1. During the fall of the upper substrate 5, the air is discharged in a privileged manner above the raised portion 4 then upstream of the propagation of the bonding wave.

According to another variant illustrated in FIG. 4, the raising member 3 extends through the thickness of the plate 10. The raising member 3 is in particular configured to be adjustable in height, typically between 1/5 and 2 times the thickness of the lower substrate 2 so as to select a deformation amplitude adapted for the direct bonding without creating a secondary bonding wave. This adjustment possibility may be provided for example by the existence of a threading provided on a finger-shaped raising member 3 and complementary threading in an orifice arranged in the plate 10 enabling the screwing or the unscrewing of the finger in the plate 10 (not illustrated).

FIG. 5 illustrates a second embodiment of the method in which the plate 10 is inclined relative to the horizontal at an angle α of about 10° by the presence of a pad 8 (FIG. 5—step i). Moreover, a raising member 3 identical to the raising member described with reference to FIG. 4 ensures obtaining the deformation and the inflection zone in the lower substrate 2. In this second embodiment, the direct bonding is carried out under vacuum from the lower 2 and upper 5 substrates, prepared to the bonding in the same way as the bonding described for the preceding embodiment. The upper substrate 5 is positioned in vertical alignment with the deformed lower substrate 2 (step c). It is maintained substantially parallel to a flat receiving portion of the carrier 1 by wedge members (not shown) such that the location of the initial contact point 6 takes place on the raised portion 4 of the lower substrate 2. As illustrated in FIG. 5 the carrier 1 further comprises a stop 9 enabling aligning the peripheral edges of the substrates 2,5 to be bonded. Once the vacuum produced, the wedge members holding the upper substrate 5 in place are removed to enable a fall by gravity. The initial contact point 6 actually takes place on the raised portion 4 of the lower substrate 2 and the bonding takes place without the occurrence of secondary bonding wave.

Alternatively, the angle of inclination α of the carrier 1 relative to the horizontal is selected between a value greater than 0 and lower than or equal to 85° and preferably between a value greater than 0 and lower than or equal to 45° so as to obtain the optimum raising of the portion 4 of the lower substrate 2.

The inclination of the carrier 1 may be alternatively obtained by a device 11 for adjusting the inclination located for example in the extension of the rising member 3, as illustrated in FIG. 6.

This embodiment generating a deformation and an inflection zone 5 in the lower substrate 2, it can also be executed under a pressure greater than the prssure of vacuum, without causing the formation of a secondary bonding wave.

According to another variant illustrated in FIG. 7, the inclination is obtained by the shaping itself of the carrier 1 which comprises a portion for receiving the lower substrate 2 generally inclined relative to the horizontal at the angle α.

FIG. 8 illustrates another embodiment which differs from the preceding ones in that the carrier 1 is not configured to generate a deformation and an inflection zone in the lower substrate 2. Indeed, the carrier 1 is inclined at the angle of inclination α as defined hereinabove, leading to form the raised zone 4 in the lower substrate 2. It is therefore possible to proceed with the direct bonding by falling by gravity the upper substrate 5 under a vacuum atmosphere, typically lower than 100 Pa, while avoiding the generation of a secondary bonding wave.

As illustrated in FIGS. 8 and 9, such a carrier 1 having a surface for receiving the inclined lower substrate 2 may be obtained in different ways such as by providing a carrier 1 intrinsically having the angle of inclination α or by providing a carrier 1 under which a pad 8 is positioned.

Thus, the method of the invention provides a direct bonding method enabling initiating a single bonding wave at a predetermined position. This method allows obtaining a direct bonding under ambient atmosphere or under vacuum, without requiring a dedicated device for applying a local pressure, by using only gravity to operate the contact between the two substrates. Moreover, the method of the invention also enables controlling the location of the initiation of the bonding on the raised portion of the lower substrate 2 and preventing a secondary bonding wave at low pressure in particular thanks to the adjustment of the parallelism between the upper substrate 5 and that of the carrier 1. The invention thus subtracts from the problematic related to the synchronization of the fall of the upper substrate 5 and the application of the local pressure determining the starting point of the bonding of the known techniques.

It goes without saying that the invention is not limited to the embodiments described hereinabove by way of examples but that it encompasses all technical equivalents and variants of the described means as well as the combinations thereof.

1. A direct bonding method between a lower substrate and an upper substrate comprising the following steps:
a) providing a carrier,
b) positioning the lower substrate on the carrier, the carrier being configured so as to raise a portion of the lower substrate,
c) positioning the upper substrate above the lower substrate,
d) allowing the falling by gravity of the upper substrate on the lower substrate so as to form an initial contact point between the upper substrate and the lower substrate, located on the raised portion of the lower substrate, and
e) completing the contacting of the upper substrate and the lower substrate so as to bond the upper substrate and the lower substrate by direct bonding.

2. The direct bonding method according to claim 1, wherein step a) for providing a carrier comprises the provision of a plate and a raising member arranged on the plate, the plate and the raising member being configured to deform the lower substrate by gravity, so as to form said raised portion and an inflection zone in the lower substrate in step b).

3. The direct bonding method according to claim 2, wherein the raising member has a height comprised between 0.05 and 3 times the thickness of the lower substrate.

4. The direct bonding method according to claim 2, wherein the raising member is configured to be adjustable in height, and in which the method comprises prior to step d) a step m) consisting in adjusting the height of the raising member.

5. The direct bonding method according to claim 2, wherein the raising member extends through the thickness of the plate.

6. The direct bonding method according to claim 2, wherein the raising member is a removable spacer.

7. The direct bonding method according to claim 2, wherein the plate is integral with the raising member.

8. The direct bonding method according to claim 1, wherein the carrier provided in step a) comprises a receiving portion of the lower substrate, the receiving portion being flat, and in which step c) comprises the positioning of the upper substrate substantially parallel to the receiving portion of the carrier.

9. The direct bonding method according to claim 1, comprising a step i) carried out prior to step b) consisting in inclining the carrier relative to the horizontal at an angle of inclination (α).

10. The direct bonding method according to claim 9, wherein the angle of inclination (α) is greater than 0 and lower than or equal to 85°.

11. The direct bonding method according to claim 1, wherein the carrier comprises at least one stop configured so that at least one peripheral part of the upper substrate and at least one part of the lower substrate are aligned against the stop.

12. The direct bonding method according to claim 1, comprising a step k) for detecting the bonding wave between the lower substrate and the upper substrate.

13. The direct bonding method according to claim 12 comprising a step I) including the lowering of the raised portion of the lower substrate when the bonding wave is detected.

14. The direct bonding method according to claim 2, wherein step d) is carried out under an atmosphere greater than or equal to vacuum.

15. The direct bonding method according to claim 1, wherein step c) is carried out under a vacuum atmosphere.
